(19) United States
(12) Patent Application Publication
(10) Pub. No.: US 2007/0058110 A1
(43) Pub. Date: Mar. 15, 2007

(54) Liquid crystal display

(76) Inventors: Daisuke Kajita, Hitachi (JP); Yuka Utsumi, Hitachi (JP); Ikuo Hiyama, Hitachinaka (JP); Masahiro Ishii, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/514,220

(22) Filed: Sep. 1, 2006

(30) Foreign Application Priority Data
Sep. 14, 2005 (JP) 2005-266211

(51) Int. Cl. G02F 1/1335

(52) U.S. Cl. 349/96

(57) ABSTRACT

A liquid crystal display has a liquid crystal panel having a liquid crystal layer sandwiched by a pair of substrates, and a backlight unit, wherein a reflective polarizer is arranged between a first substrate and the backlight unit; when λ0 [nm] is defined as a wavelength at which a spectral reflectance R of the reflective polarizer shows the maximum value, the reflective polarizer has such a wavelength λ0 [nm] that the following value R1 obtained by integrating the spectral reflectance with respect to a wavelength λ [nm] between λ0−50 [nm] and λ0+50 [nm]:
R1=∫_{λ0-50}^{λ0+50}Rdλ and the following value R2 obtained by integrating the spectral reflectance with respect to wavelengths between 400 nm and 700 nm:
R2=∫₄₀₀⁷⁰⁰Rdλ satisfy the relation of R1/R2>0.4; and the reflective polarizer has a reflection axis in approximately parallel to an absorption axis of a first polarizing plate consumption to greatly improve all the performances, with a simple configuration.

### BACKGROUND OF THE INVENTION

1. Field of the Invention

The present invention relates to a liquid crystal display, and particularly to a liquid crystal display which greatly improves a brightness efficiency of electric power, a color specification range and a contrast ratio.

2. Description of Related Art

A technology on a liquid crystal display has remarkably progressed in recent years, and has been already widely practically used in an oversize TV for home use, a monitor for a personal computer, a personal digital assistant and the like. As the application field expands, needs for the enhancement of picture quality and lower power consumption further increase.

Requirement for the improvement on the enhancement of picture quality includes the widening of an effective visual angle, increase in a contrast ratio and the expansion of a color specification range.

For instance, as for the widening of an effective visual angle, a wide visual angle liquid crystal display mode is going to be practically used. As for a system of applying an electric field on a liquid crystal in a parallel direction to a substrate (hereafter called a transversal electric field system or an IPS mode), the system having a comb electrode provided on one sheet of a substrate is proposed in JP-B-63-21907, JP-A-09-80424 and JP-A-2001-056476. It is known that the system provides a wide visual angle, because in the system, liquid crystal molecules rotate mainly in a plane parallel to the substrate, so that even when the display is viewed from an angle, the birefringence does not show much difference between the time when the electric field is applied and the time when not applied. In additions to this, there are a VA mode (JP-A-11-242225) in which the liquid crystal molecules are vertically oriented to the substrate when voltage is not applied, and an OCB mode (JP-A-07-084254) using bend orientation. A technology for increasing a contrast ratio also has to greatly depend on these liquid crystal display modes, and in order to employ the modes, a manufacturing process has to be greatly changed.

As for the expansion of a color specification range, characteristics of an emission spectrum in a lighting unit and a color filter have been improved. Currently, in a middle-to-large-screen liquid crystal display, a fluorescent lamp (cold cathode fluorescent tube, hot cathode fluorescent tube or the like) is generally used for a light source of the lighting unit. Accordingly, the color specification range of the liquid crystal display is generally determined by an emission spectrum of a phosphor used in the fluorescent lamp. In recent years, a fluorescent lamp with high color-rendering properties with the use of a new phosphorss has been developed (JP-A-2004-101705), and has been partly applied to the lighting unit of a liquid crystal display. As another measure, there is a method of applying a light-emitting diode to the lighting unit (JP-A-2004-29141). In general, the light-emitting diode shows a narrower emission spectrum than the phosphorss, and accordingly can realize a lighting unit with high color-rendering properties. However, any of these means increases a power consumption of a liquid crystal display, and requires a large change for a manufacturing process.

On the other hand, as for the reduction of a power consumption, it is important to improve the transmittance of a liquid crystal display portion and the efficiency of a lighting unit.

As for improvement in the efficiency of a lighting unit, a prism (JP-A-09-73004) for condensing light emitted from a light source into the front of a display unit and a reflective polarizer (JP-A-1997-506837) have been practically used.

An example of a reflective polarizer shown in JP-A-1997-506837 is shown in FIG. 2. In the figure, 30-A shows a thin film having birefringence in a plane (x-y plane), and when nxA represents a refractive index in x direction and nyA represents a refractive index in y direction, satisfies nxA>nyA. On the other hand, 30-B shows a thin film having an isotropic refractive index, and when nxA represents a refractive index in x direction and nyA represents a refractive index in y direction, satisfies nxB=nyB. Furthermore, a relationship of nyA=nyB is satisfied, and the two thin films are layered. When a linear polarized light in x direction is incident perpendicularly (z direction) to the thin film, the light reflects on an interface between 30-A and 30-B. On the other hand, when a linear polarized light in y direction is incident on the thin film, there is no interface between layers having different indices, so that all the light transmits. Thereby, a reflective polarizer is realized. Hereafter, in a reflective polarizer, an axis showing a high reflectance (x direction in case of FIG. 2) is referred to as a reflection axis, and an axis showing a low reflectance (y direction in FIG. 2) is referred to as a transmission axis. In addition, the reflectance of the reflective polarizer shall mean the reflectance of a linear polarized light which is polarized in a direction parallel to the reflection axis and has been perpendicularly incident on to the reflective polarizer.

The reflective polarizer can acquire a higher reflectance to a certain linear polarized light by increasing the multilayered number of thin films, as shown in FIG. 3. In other words, the reflective polarizer can increase a degree of the polarization of transmitted light.

Means for realizing a reflective polarizer is not limited to this, but includes means using a wire grid shown in JP-A-02-308106 and means using a cholesteric liquid crystal shown in JP-A-2003-227933.

The efficiency of a liquid crystal display can be improved and the power consumption can be decreased by placing a reflective polarizer 30 between a lighting unit 50 and a liquid crystal display portion 10, as is shown in FIG. 4. In the figure, a reflection axis of the reflective polarizer 30 is generally parallel to an absorption axis of a first polarizing plate 12. When the reflective polarizer 30 is not placed there, about half the light of unpolarized light emitted from the lighting unit 50 and incident on the polarizing plate 12 is absorbed in therein. However, when the reflective polarizer 30 is arranged, a polarized component originally to be absorbed in the polarizing plate 12 is reflected on the reflective polarizer 30 and returns to the lighting unit 50. One part of the light changes to a polarized light which can transmit through the reflective polarizer before being incident on the reflective polarizer 30 again, and transmits through the reflective polarizer 30 and the polarizing plate 12. The other light is reflected on the reflective polarizer 30 again. The configuration having the reflective polarizer 30 thus repeats the process, and makes a more amount of light transmit through the polarizing plate 12 than the configuration having no reflective polarizer 30 placed does.

A problem to be solved is to simultaneously realize the expansion of a color specification range, increase in a contrast ratio and the reduction of power consumption by simple means.

### SUMMARY OF THE INVENTION

A liquid crystal display according to the present invention comprises: a first substrate provided with a first polarizing plate in a light incident side; a second substrate provided with the other second polarizing plate; liquid crystal molecules sandwiched by the two substrates; a group of matrix-driven electrodes which applies an electric field to the liquid crystal layer, and is arranged in a side close to the liquid crystal layer of at least any one substrate of the first substrate and the second substrate; a color filter for trichromatic display placed on any one of the first substrate and the second substrate; and a backlight unit; wherein

a reflective polarizer is arranged between the first substrate and the backlight unit; when λ0 [nm] is defined as a wavelength at which a spectral reflectance R of the reflective polarizer (spectral reflectance when linear polarized light parallel to a reflection axis is perpendicularly incident) shows the maximum value, the reflective polarizer has such a wavelength λ [nm] that the following value obtained by integrating the spectral reflectance with respect to the wavelength λ [nm] between λ0−50 [nm] and λ0+50 [nm]:

$$R 1 = {\int }_{λ 0 - 50}^{λ 0 - 50} R ⅆ λ$$

and the following value obtained by integrating the spectral reflectance with respect to the wavelength between 400 nm and 700 nm:

$$R 2 = {\int }_{400}^{700} R ⅆ λ$$

satisfy the relation of R1/R2>0.4; and the reflective polarizer has a reflection axis in approximately parallel to an absorption axis of the first polarizing plate (so as to form a smaller side angle of 0 to 10 degrees).

A liquid crystal display according to the present invention greatly improves the brightness efficiency of electric power, a color specification range and a contrast ratio, by specifying the configuration of a lighting unit, a reflective polarizer, a polarizing plate and a liquid crystal layer, a light source of the lighting unit, a reflection spectrum of the reflective polarizer and a transmission spectrum of the liquid crystal display portion.

### BRIEF DESCRIPTION OF THE DRAWINGS

FIG. 1 is a block diagram showing one embodiment of a liquid crystal display according to the present invention;

FIG. 2 is an explanatory drawing of a reflective polarizer used in one embodiment according to the present invention;

FIG. 3 is an explanatory drawing of a reflective polarizer used in one embodiment according to the present invention;

FIG. 4 is an explanatory drawing of a reflective polarizer used in one embodiment according to the present invention;

FIG. 5 is a characteristic view showing a relative relation between a color temperature in displaying white and the brightness of a lighting unit in a liquid crystal display with the use of a general fluorescent lamp;

FIG. 6 is a characteristic view showing a relative relation between a retardation and spectral transmittance in a liquid crystal layer of a general liquid crystal display with the use of an IPS mode;

FIG. 7 is a characteristic view showing a relative relation between a retardation and a contrast ratio in a liquid crystal layer of a general liquid crystal display with the use of an IPS mode;

FIG. 8 is a comparative diagram of spectra between red phosphorsss used in a fluorescent lamp;

FIG. 9 is a spectral reflectance of a reflective polarizer used in one embodiment according to the present invention;

FIG. 10 is an emission spectrum of a backlight unit used in one embodiment according to the present invention;

FIG. 11 shows spectral transmittances of general color filters;

FIG. 12 shows a spectral reflectance of a reflective polarizer used in one embodiment according to the present invention;

FIG. 13 shows an emission spectrum of a backlight unit used in one embodiment according to the present invention;

FIG. 14 shows an emission spectrum of a backlight unit used in one embodiment according to the present invention;

FIG. 15 shows a spectral reflectance of a reflective polarizer used in one embodiment according to the present invention;

FIG. 16 shows an emission spectrum of a backlight unit used in one embodiment according to the present invention;

FIG. 17 is a block diagram showing one embodiment of a liquid crystal display according to the present invention;

FIG. 18 shows an emission spectrum of a backlight unit used in one embodiment according to the present invention;

FIG. 19 shows a spectral reflectance of a reflective polarizer used in one embodiment according to the present invention;

FIG. 20 is a block diagram showing one embodiment of a liquid crystal display according to the present invention;

FIG. 21 shows an emission spectrum of a backlight unit used in one embodiment according to the present invention;

FIG. 22 shows a spectral reflectance of a reflective polarizer used in one embodiment according to the present invention; and

FIG. 23 shows a spectral reflectance of a reflective polarizer used in one embodiment according to the present invention.

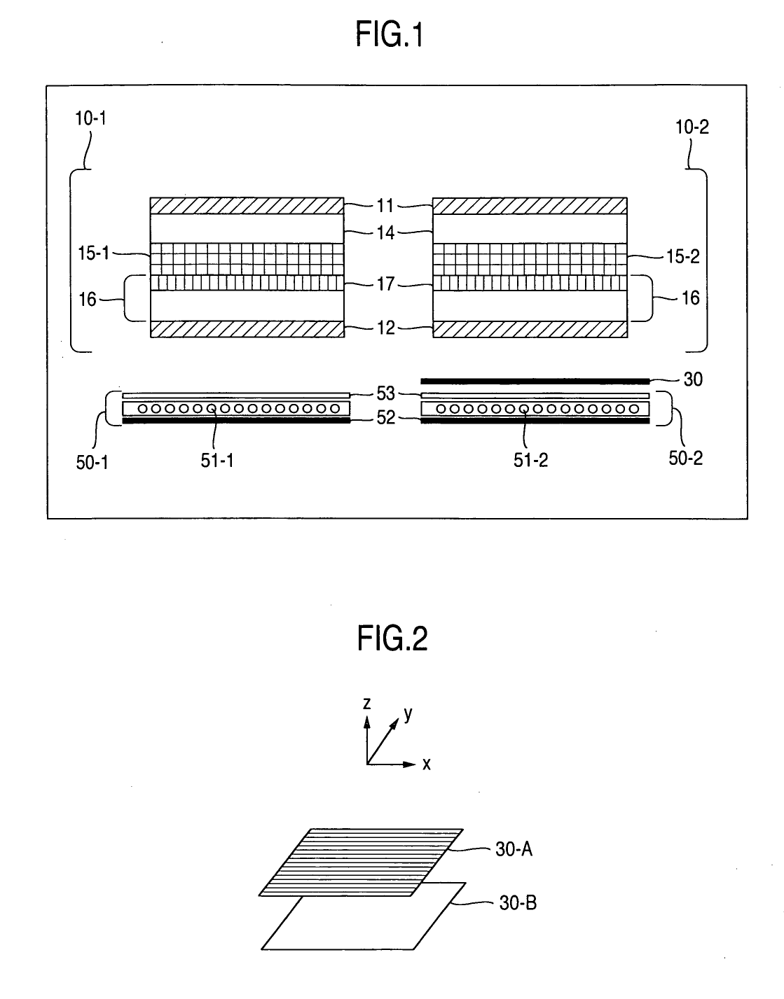

### DETAILED DESCRIPTION OF THE INVENTION

In the next place, a content of the present invention will be specifically described.

As a liquid crystal TV becomes more popularly used, the liquid crystal display is required to satisfy the following performances simultaneously.

High color-temperature (6000 K or higher) in displaying white
High brightness in displaying white
High contrast ratio
Wide color specification range
Low power consumption

However, it is impossible to simultaneously satisfy the above requirements only by combining conventionally known techniques.

For instance, it is necessary to raise a color temperature of a lighting unit in order to raise the color temperature in displaying white. When the lighting unit employs a fluorescent lamp, it is necessary to increase a mixture ratio of a blue phosphorss in order to raise the color temperature. However, the increase of a blue phosphor increases the power consumption of the fluorescent lamp, because the luminous efficiency of the blue phosphor is lower than those of normally used red and green phosphors. In addition, even if the mixture ratio of the phosphors is changed, a color specification range is not greatly changed. FIG. 5 shows an example of correlation between a color temperature and the brightness of a lighting unit (when power consumption is constant) when a color temperature of a liquid crystal display in displaying white is changed by changing the mixture ratio of phosphorss. In the used liquid crystal display, an IPS mode is employed as a liquid crystal display mode, and the lighting unit employs a cold cathode fluorescent tube as its light source, which are general as a liquid crystal display. It is understood from the figure that as the lighting unit makes its color temperature higher, the light-emitting efficiency decreases.

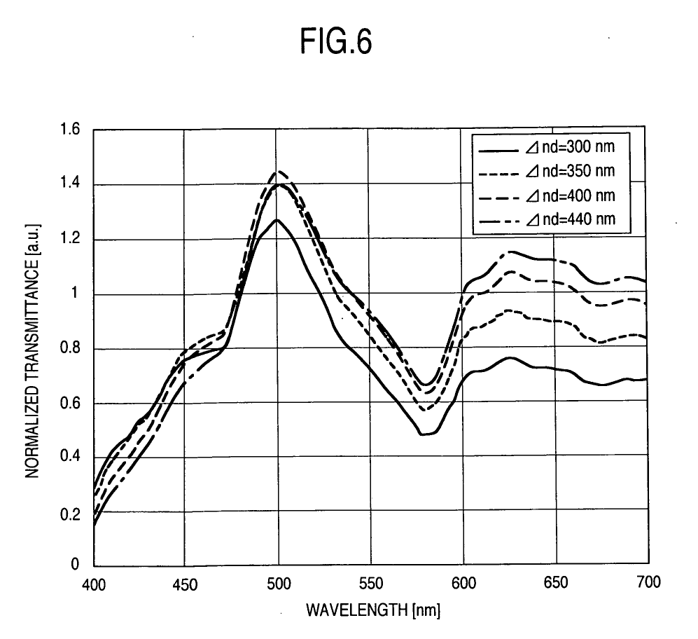

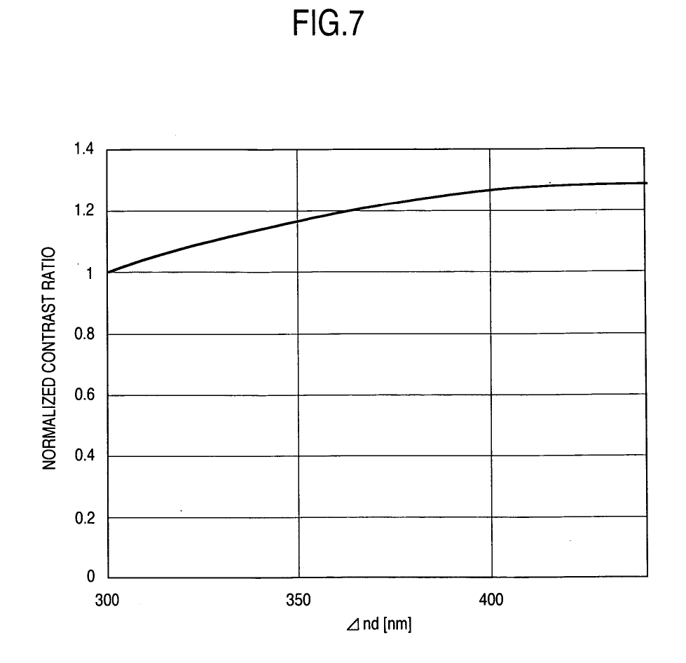

It is considered to increase the transmittance of a blue light in a liquid crystal display portion, as another means, but when the spectral transmittance of the blue light increases, luminous efficacy transmittance decreases particularly in a liquid crystal display mode such as an IPS transmission mode and a VA transmission mode realize, which realizes white display by using the birefringence of a liquid crystal layer. In other words, the brightness in displaying white decreases. FIG. 6 shows an example of correlation between a retardation Δnd of the liquid crystal layer (where (Δn) is a birefringent refractive index of a liquid crystal layer and (d) is a thickness of the liquid crystal layer) and the spectral transmittance of a liquid crystal display portion in the liquid crystal display of an IPS mode. It is understood that when the retardation of the liquid crystal layer is small, the spectral transmittance of blue light is large, but the spectral transmittance of green light to red light is small. On the other hand, the spectral transmittance in black display does not depend on the retardation of the liquid crystal layer employing an IPS mode or a VA mode. Accordingly, a contrast ratio is predominantly determined by luminous efficacy transmittance in displaying white. FIG. 7 shows the relation. It is understood that when a color temperature in displaying white is increased by decreasing the retardation of the liquid crystal layer, the contrast ratio is decreased.

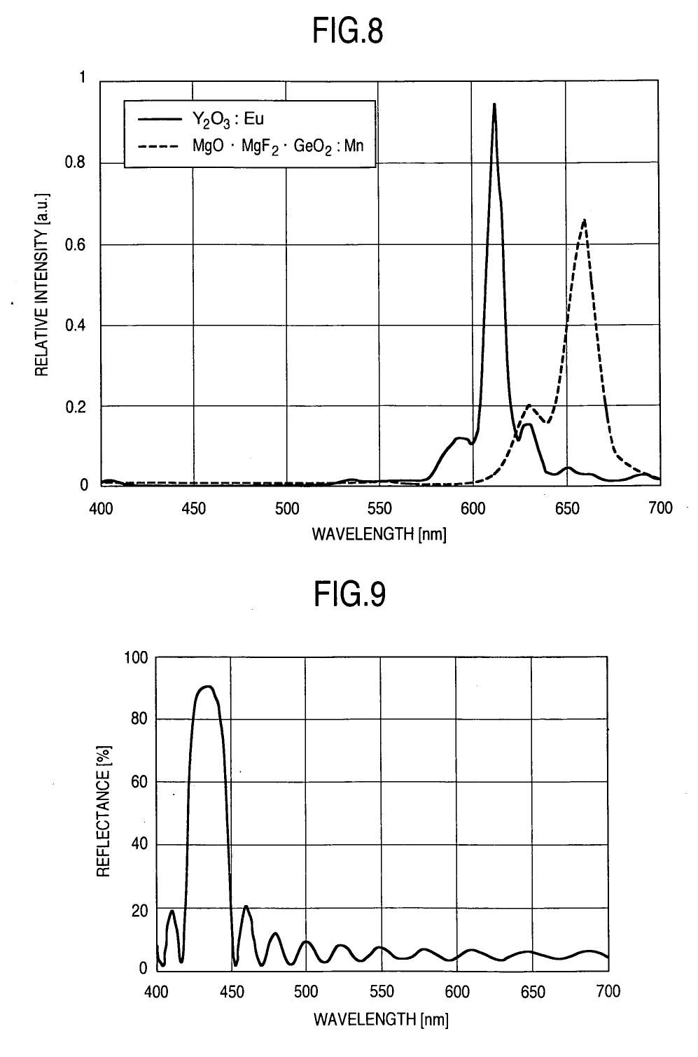

It is necessary to improve color-rendering properties of a lighting unit in order to expand a color specification range. In a normal fluorescent lamp, Y₂O₃:Eu is used as a red phosphors, LaPO₄:Tb, Ce is as a green phosphors and BaMgAl₁₀O₁₇:Eu is as a blue phosphors. But phosphors other than those have to be used in order to improve the color-rendering properties of the lighting unit and thereby to expand the color specification range of the liquid crystal display. However, according to our examination, when the color rendering property of a fluorescent lamp is improved by changing a luminescent material, the brightness efficiency of electric power greatly decreases, in the present situation. For instance, there are a plurality of types of the phosphors for improving red purity. A normally used red luminescent material Y₂O₃:Eu has a luminescence peak in a wavelength of 610 nm, whereas a red luminescent material, for instance, MgO—MgF₂—GeO₂:Mn shows a luminescence peak at 660 nm. FIG. 8 shows emission spectra of two phosphors appearing when excited by ultraviolet light with a wavelength of 254 nm. As is clear from the figure, MgO—MgF₂—GeO₂:Mn has lower luminous efficiency than Y₂O₃:Eu. In addition, the efficiency further decreases after the spectrum is corrected by luminous efficacy and is converted to brightness. Accordingly, when expanding the color specification range by changing the fluorescent lamp, the liquid crystal display results in the increase of its power consumption or the decrease of its brightness in displaying white.

A configuration of a liquid crystal display according to the present invention is shown in the right side of FIG. 1. The left side of FIG. 1 shows a general liquid crystal display as a comparative object. In the left side of FIG. 1, 12 shows a first polarizing plate arranged in a light incidence side, and 16 shows a first substrate which includes a group of matrix electrodes 17 for applying an electric field to a liquid crystal layer 15-1. An electrode structure and the liquid crystal layer 15-1 are the same type as an IPS mode described in JP-A-2001-056476. Reference numeral 14 is a second substrate, and 11 is a second polarizing plate in a light-emitting side. A liquid crystal display portion 10-1 is composed of them. A backlight unit 50-1 consists of a subsurface reflecting plate and subsurface frames 52, a cold cathode fluorescent tube 51-1, and a group of optical sheets 53 including a diffusing plate and a condensing sheet. The liquid crystal display according to the present invention shown in the right of FIG. 1 has a cold cathode fluorescent tube 51-2 which seals a different ratio of phosphor materials from and a different emission spectrum from those of 51-1 therein. The liquid crystal display has a liquid crystal layer 15-2 having a higher retardation than the liquid crystal layer 15-1. The liquid crystal display has a reflective polarizer 30 placed between the backlight unit 50-2 and the liquid crystal display portion 10-2.

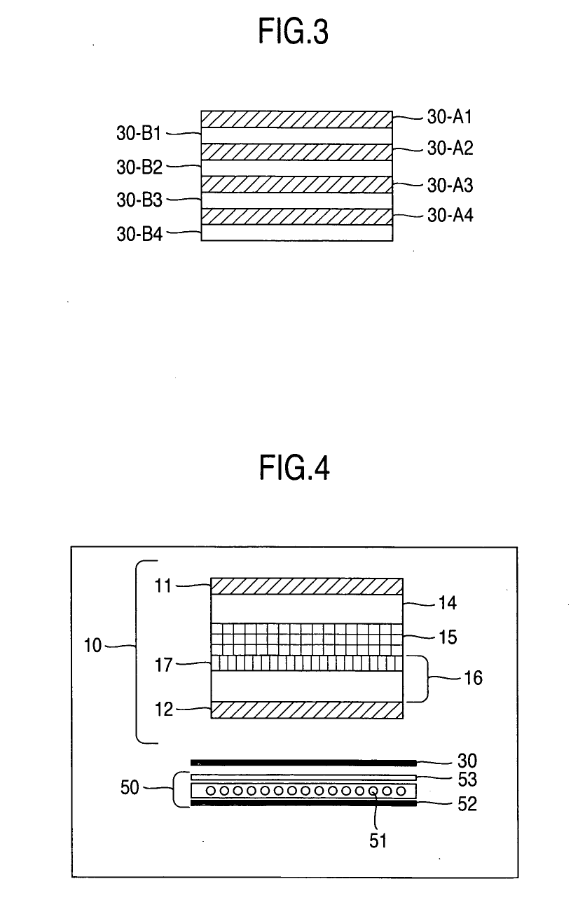

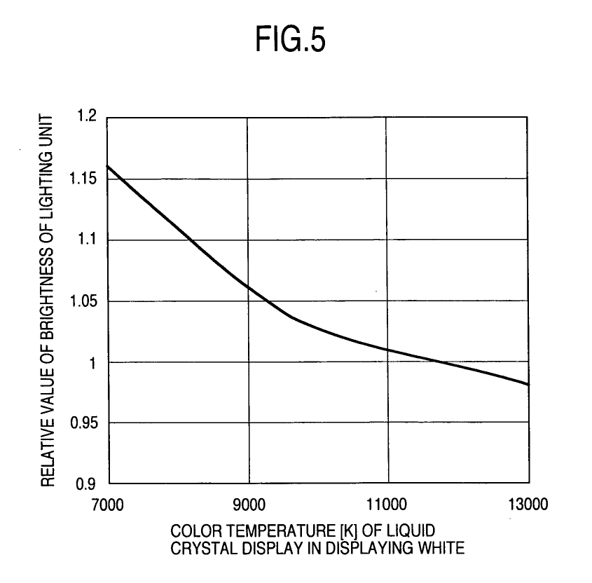

Here, the reflective polarizer 30 has a spectral reflectance which shows the maximum value in a blue range of 500 nm or shorter, as is shown in FIG. 9. The reflective polarizer is obtained by preparing birefringent films 30-A having a refractive index of 1.6 for an extraordinary ray and a film thickness of 70 nm, and isotropic layers having a refractive index of 1.5 and a film thickness of about 70 nm, and stacking about 20 layers of them respectively so as form a configuration, for instance, of the reflective polarizer in FIG. 3.

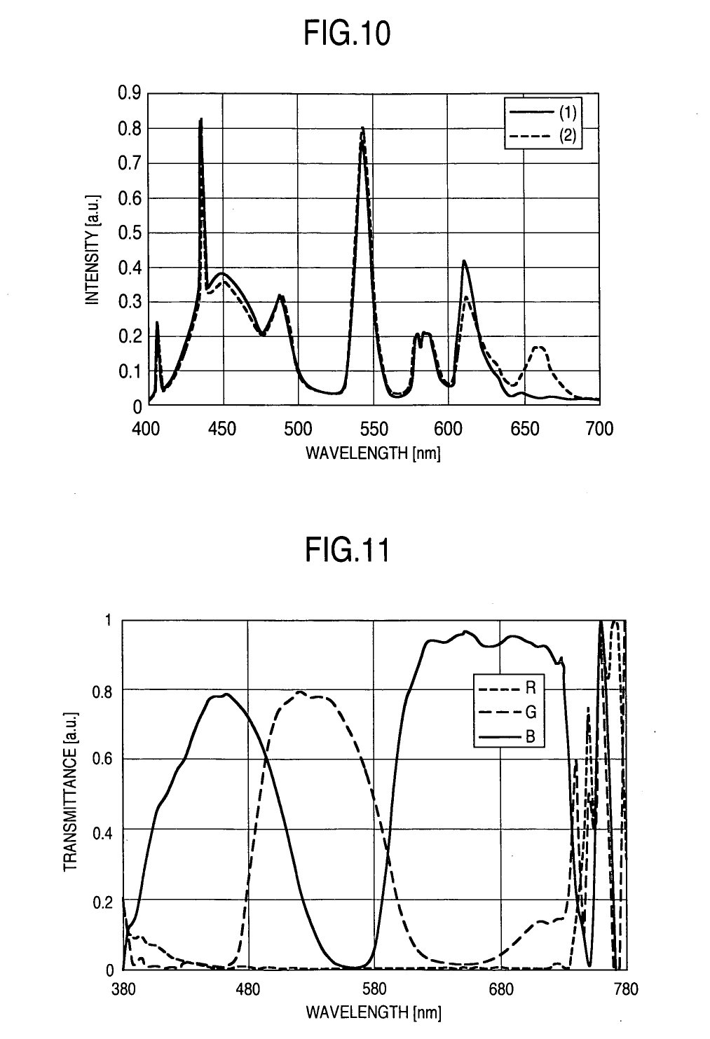

FIG. 10 shows a result of having compared emission spectra between backlight units 50-1 and 50-2. In the figure, (1) shows an emission spectrum of a backlight unit 50-1, and (2) shows an emission spectrum of a backlight unit 50-2. The backlight unit showing an emission spectrum of (2) includes a lower ratio of a blue phosphor and correspondingly a higher ratio of a green phosphor and a red phosphor than that of (1). The backlight unit showing an emission spectrum of (2) also includes Y₂O₃:Eu and MgO—MgF₂—GeO₂: Mn as the red phosphors, and accordingly emits light with a longer wavelength range than that of (1).

A liquid crystal layer 15-1 generates a retardation of 380 nm, and a liquid crystal layer 15-2 generates a retardation of 400 nm. A spectral transmittance in a liquid crystal display portion is shown in FIG. 6.

A liquid crystal display shown in the left side of FIG. 1 showed a brightness of 510 cd/m² in displaying white, a color temperature of 10,000 K in displaying white, a chromaticity of x=0.653 and y=0.326 when displaying red, a chromaticity of x=0.143 and y=0.0784 when displaying blue, and a contrast ratio of 830. In contrast to this, the liquid crystal display having the configuration according to the present invention shown in the right side of FIG. 1 showed the brightness of 520 cd/m² in displaying white, the color temperature of 10,200 K in displaying white, the chromaticity of x=0.661 and y=0.311 when displaying red, the chromaticity of x=0.136 and y=0.0801 when displaying blue and the contrast ratio of 870. It can be understood that the liquid crystal display according to the present invention improves simultaneously all the required performances.

In the next place, the principle of the present invention will be described. First, a reflective polarizer applied to the liquid crystal display has a spectral reflectance peak in blue particularly in a short wavelength range as shown in FIG. 9, and accordingly makes short-wavelength light transmit through a first polarizing plate much more than a case having no reflective polarizer applied. Therefore, the liquid crystal display can increase its blue-color purity. It is possible to sufficiently increase blue-color purity by making the liquid crystal display employ particularly such a reflective polarizer as to reflect only a short wavelength of 470 to 480 nm, which is the shortest wavelength transmissible in a green-color filter, because color filters to be used for color display have an overlapping region in spectral transmittances of blue color and green color around a wavelength 500 nm as shown in FIG. 11.

Furthermore, it becomes possible to greatly reduce a mixture ratio of a blue phosphor material to be sealed in a fluorescent lamp, because the use efficiency of blue light substantially increases in the lighting unit. Correspondingly, the lighting unit can seal a more amount of green and red phosphor materials into it. As described above, a blue phosphor material has the lowest luminous efficiency, so that the brightness efficiency of electric power for a fluorescent lamp is greatly improved at this time. Then, a red phosphor having a luminescence peak in a long wavelength range can be used without causing a side effect of increase in power consumption, in order to improve the red purity of the liquid crystal display.

Furthermore, it is possible to increase a color temperature in displaying white by decreasing a spectral transmittance of a liquid crystal display portion in a short wavelength range and increasing it in a long wavelength range. The color temperature can be increased by increasing an effective retardation of a liquid crystal layer in displaying white, as was described above. As a result, brightness in displaying white and a contrast ratio increase. In the above description, the liquid crystal display portion uses the same type as an IPS mode in JP-A-2001-056476, and shows the contrast ratio generally pursuant to properties shown in FIG. 7.

As is understandable from the above description, the liquid crystal display according to the present invention solves a trade-off relation among performances required to a liquid crystal display, such as a high color temperature in displaying white, high brightness in displaying white, a high contrast ratio, a wide color specification range and a low power consumption. As was described in the present embodiment, the liquid crystal display the present invention can simultaneously improve all the performances, or can improve the brightness or the power consumption greatly while keeping other performances. The liquid crystal display can change the improvement ratio for the performances by changing a spectral reflectance of a reflective polarizer, an emission spectrum of a backlight unit (phosphor materials and a mixture ratio therein when a fluorescent lamp is used), and an effectiveness retardation of a liquid crystal layer in displaying white.

A spectral reflectance of a reflective polarizer in the present invention is decided in accordance with an advantage and a disadvantage of a light source to be used, but according to our examination for sufficiently obtaining the advantage offered by the present invention, the reflective polarizer has only to have a wavelength λ0 [nm] at which a spectral reflectance R of the reflective polarizer shows the maximum value, so that a value obtained by integrating the spectral reflectance with respect to the wavelength λ [nm] between λ0−50 [nm] and λ0+50 [nm]:

$$R 1 = {\int }_{λ0 - 50}^{λ0 - 50} R ⅆ λ$$

and a value obtained by integrating the spectral reflectance with respect to the wavelength between 400 nm and 700 nm:

$$R 2 = {\int }_{400}^{700} R ⅆ λ$$

satisfy the relation of R1/R2>0.4; and have a reflection axis in approximately parallel (a smaller side angle of 0 to 10 degrees) to an absorption axis of the first polarizing plate. Alternatively, when R0 is defined as the maximum value of a spectral reflectance of the reflective polarizer, the reflective polarizer may have at least two such wavelengths as to satisfy the relation of R=R0/2 in a wavelength range of 700 nm or shorter and such wavelengths that a wavelength λ1 [nm] which is larger than λ0 and has the minimum difference between itself and λ0 and a wavelength λ2 [nm] which is smaller than λ0 and has the minimum difference between itself and λ0 satisfy the relation of λ1−λ2<100 nm.

A fluorescent lamp in the present embodiment employs MgO—MgF2—GeO2:Mn as a phosphor in order to improve red purity, but it is also possible to improve green purity or further blue purity while inhibiting the increase of an electric power consumption, by using BaMgAl₁₀O₁₇:Mn, Eu which improves green purity, or (Sr, Ca)ₓ(PO₄)_{y}Cl_{z}:Eu which improves blue purity, and by adequately setting a spectral reflectance of a reflective polarizer.

In the next place, a content of the present invention will be described in further detail with reference to specific embodiments. The following embodiments are specific examples for showing the content of the present invention, and the present invention is not limited by these embodiments.

### Embodiment 1

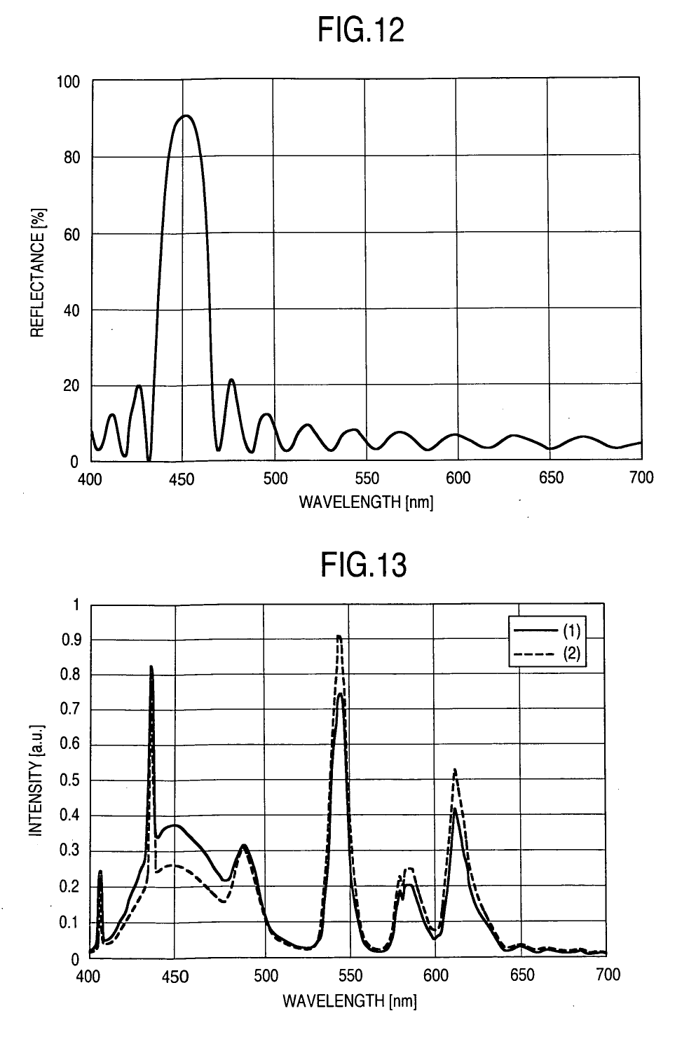

A structure of the liquid crystal display according to the present embodiment is shown in the right side of FIG. 1. The left side of FIG. 1 shows a general liquid crystal display as a comparative object. A reflective polarizer 30 shows the maximum reflectance at a wavelength of about 450 nm as is shown in FIG. 12. The reflective polarizer was obtained by preparing birefringent films 30-A having a refractive index of 1.6 for an extraordinary ray and a film thickness of 70 nm, and isotropic layers having a refractive index of 1.5 and a film thickness of about 70 nm, and stacking about 20 layers of them respectively so as form a configuration, for instance, of the reflective polarizer in FIG. 3. FIG. 13 shows a result of having compared emission spectra between backlight units, in which (1) shows an emission spectrum of a backlight unit 50-1, and (2) shows an emission spectrum of a backlight unit 50-2. As is understood from the figure, the lighting unit according to the present invention has a greatly improved use efficiency of blue light by the reflective polarizer, thereby can decrease a mixture ratio of a blue phosphor among phosphors sealed in a fluorescent lamp 51-2, and correspondingly can increase ratios of green and red phosphors. As a result of this, the liquid crystal display can increase brightness in displaying white, while keeping a color temperature in displaying white equal to that of a conventional liquid crystal display; or alternatively, can greatly reduce the power consumption, while keeping brightness in displaying white equal to that of a conventional liquid crystal display. In the present embodiment, liquid crystal layers 15-1 and 15-2 were the same type as an IPS mode described in JP-A-2001-056476, and were formed so as to show the retardation of 380 nm. As a result, the liquid crystal display according to the present invention shown in the right side of FIG. 1 showed such a greatly improved brightness in displaying white as is approximately 1.3 times higher than a conventional one, while keeping a color temperature in displaying white and power consumption approximately equal to the conventional one.

### Embodiment 2

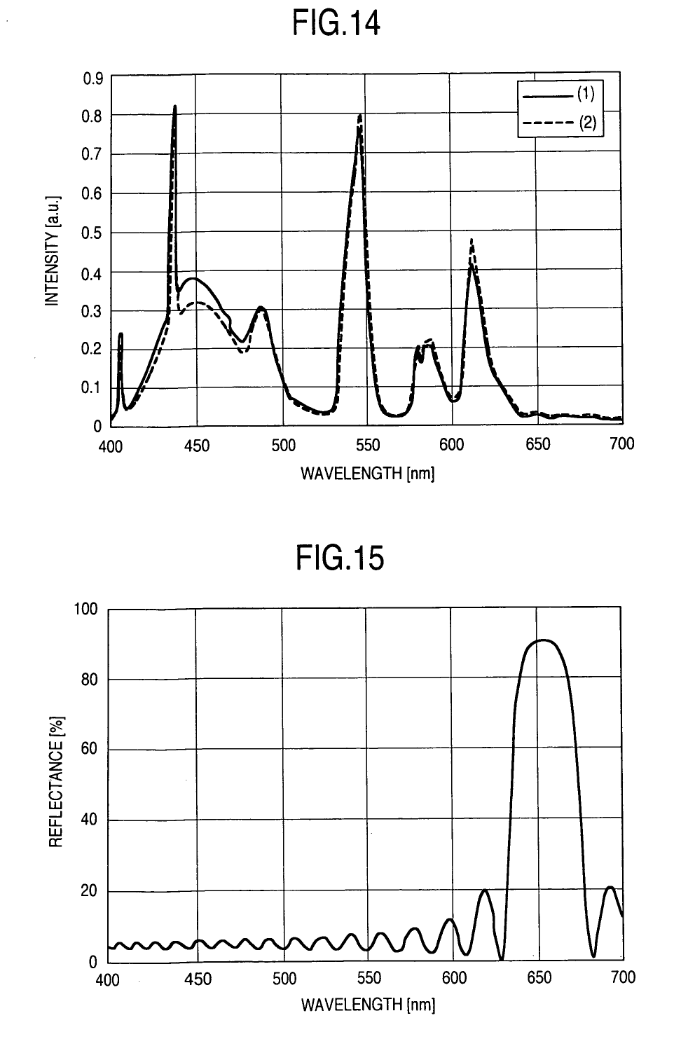

A structure of the liquid crystal display according to the present embodiment is shown in the right side of FIG. 1. The left side of FIG. 1 shows a general liquid crystal display as a comparative object. A reflective polarizer 30 showed the maximum reflectance at a wavelength of about 450 nm as is shown in FIG. 12. FIG. 14 shows a result of having compared emission spectra between backlight units, in which (1) shows an emission spectrum of a backlight unit 50-1, and (2) shows an emission spectrum of a backlight unit 50-2. In addition, liquid crystal layers 15-1 and 15-2 were the same type as an IPS mode described in JP-A-2001-056476, and were formed so as to show the retardation of respectively 350 nm and 440 nm. As a result, the liquid crystal display according to the present invention showed a contrast ratio increased by 10% and brightness in displaying white also increased by 10%, while keeping a color temperature in displaying white and power consumption approximately equal to the conventional one.

### Embodiment 3

A structure of the liquid crystal display according to the present embodiment is shown in the right side of FIG. 1. The left side of FIG. 1 shows a general liquid crystal display as a comparative object. The reflective polarizer 30 showed the maximum reflectance at a wavelength of about 660 nm as is shown in FIG. 15. The reflective polarizer was obtained by preparing birefringent films 30-A having a refractive index of 1.6 for an extraordinary ray and a film thickness of 105 nm, and isotropic layers having a refractive index of 1.5 and a film thickness of about 105 nm, and stacking about 20 layers of them respectively so as form a configuration, for instance, of the reflective polarizer in FIG. 3.

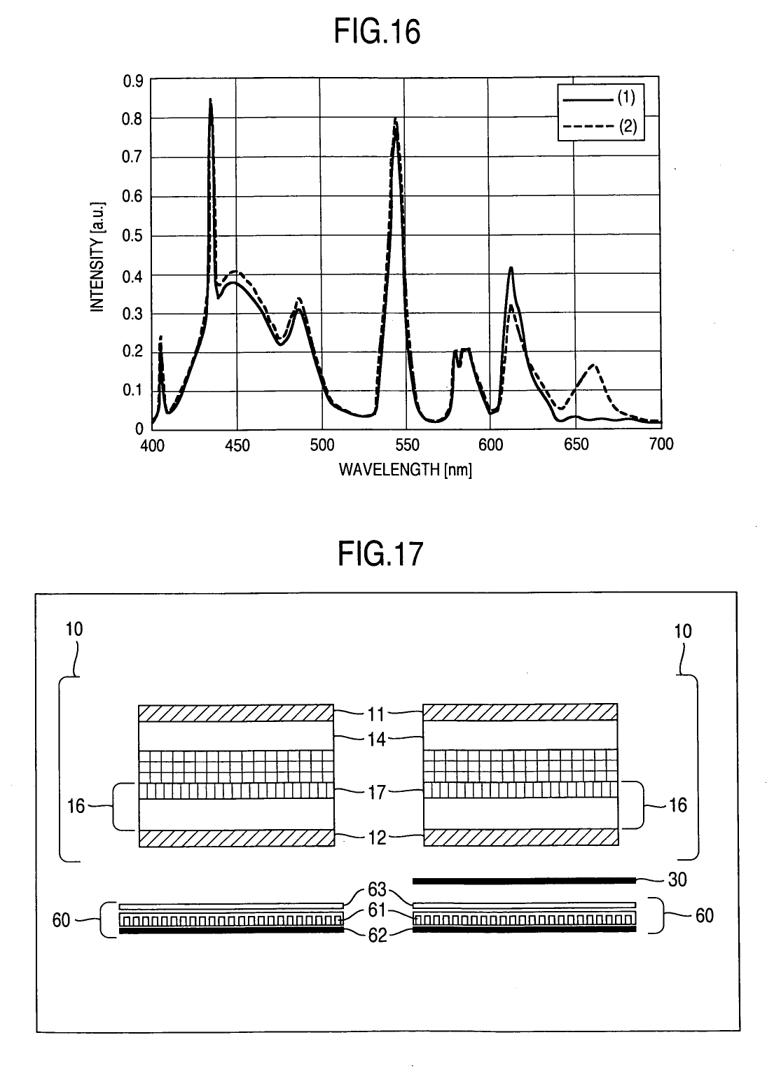

FIG. 16 shows a result of having compared emission spectra between backlight units, in which (1) shows an emission spectrum of a backlight unit 50-1, and (2) shows an emission spectrum of a backlight unit 50-2. As is understood from the figure, a cold cathode fluorescent tube 51-2 of the present embodiment uses a mixture of Y₂O₃:Eu and MgO—MgF₂—GeO₂:Mn as a red phosphor, and emits light with a longer wavelength range than that of (1). In the present embodiment, liquid crystal layers 15-1 and 15-2 were the same type as an IPS mode described in JP-A-2001-056476, and were formed so as to show the retardation of 380 nm. As a result, the liquid crystal display according to the present invention improved chromaticity in displaying red from x=0.653 and y=0.326 to x=0.670 and y=0.295, while keeping a color temperature in displaying white and power consumption approximately equal to the conventional one.

### Embodiment 4

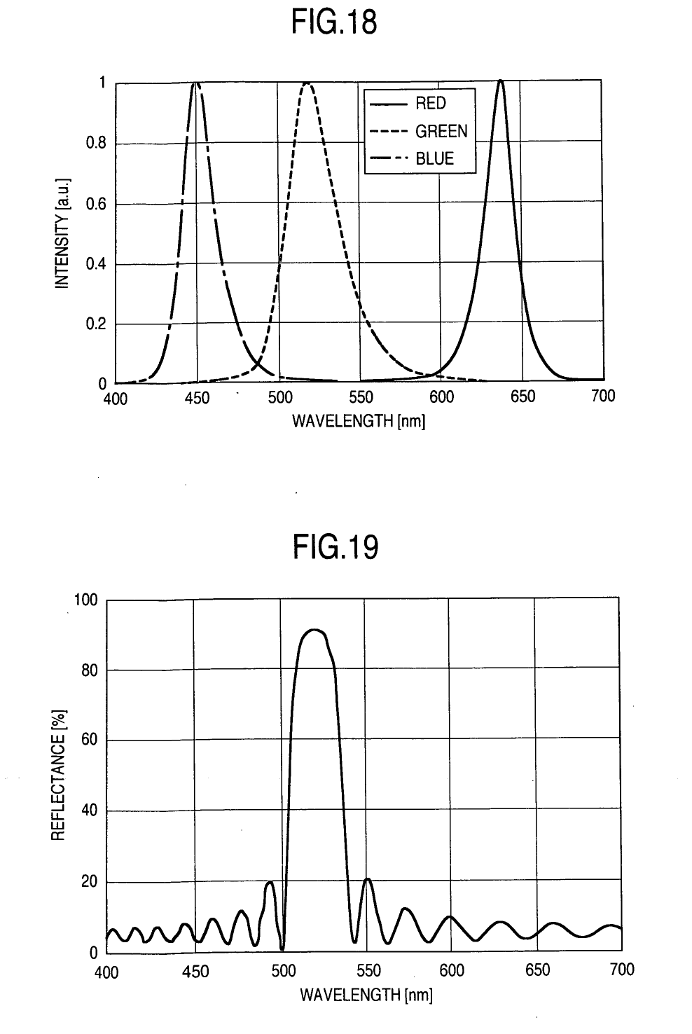

A structure of the liquid crystal display according to the present embodiment is shown in the right side of FIG. 17. In the present embodiment, a backlight unit 60 consists of a light-emitting diode 61 as a light source, a subsurface reflecting plate and subsurface frames 62, and a group of optical sheets 63 including a diffusing plate and a condensing sheet. Here, the light-emitting diode 61 can independently emit trichromatic lights of red, blue and green. A reflective polarizer 30 is arranged between the backlight unit 60 and a liquid crystal display portion 10. The left side of FIG. 17 shows a liquid crystal display as a comparative object, which uses a general backlight unit using light-emitting diodes capable of independently emitting trichromatic light, which are similar to that of the present embodiment. An emission spectrum provided by the backlight unit originates from the light-emitting diodes of red, blue and green respectively, and is shown in FIG. 18. A liquid crystal display having used the light-emitting diodes as a lighting unit as in the present embodiment shows a sufficiently wide color specification range, in comparison with a liquid crystal display using a fluorescent lamp. The color temperature in displaying white can be also adjusted by controlling an electric power charged into the respective red, blue and green light-emitting diodes. However, the lighting unit using light-emitting diodes as a light source consumes a more amount of electric power than that using the fluorescent lamp. It is particularly a green-light-emitting diode to affect the power consumption. Generally, a GaN-based semiconductor is used for blue- and green-light-emitting diodes, and a GaAs- or GaP-based semiconductor is used for a red-light-emitting diode. Among them, the green-light-emitting diode with the use of the GaN-based semiconductor shows the lowest photoelectric conversion efficiency. Accordingly, a reflective polarizer 30 in the present embodiment was formed so as to have a spectral reflectance showing the maximum value at a wavelength of about 520 nm, as shown in FIG. 19. As a result, the liquid crystal display according to the present embodiment shown in the right side of FIG. 17 showed such a greatly improved brightness in displaying white as is approximately 1.3 times higher than the conventional one, while keeping power consumption approximately equal to the conventional one.

### Embodiment 5

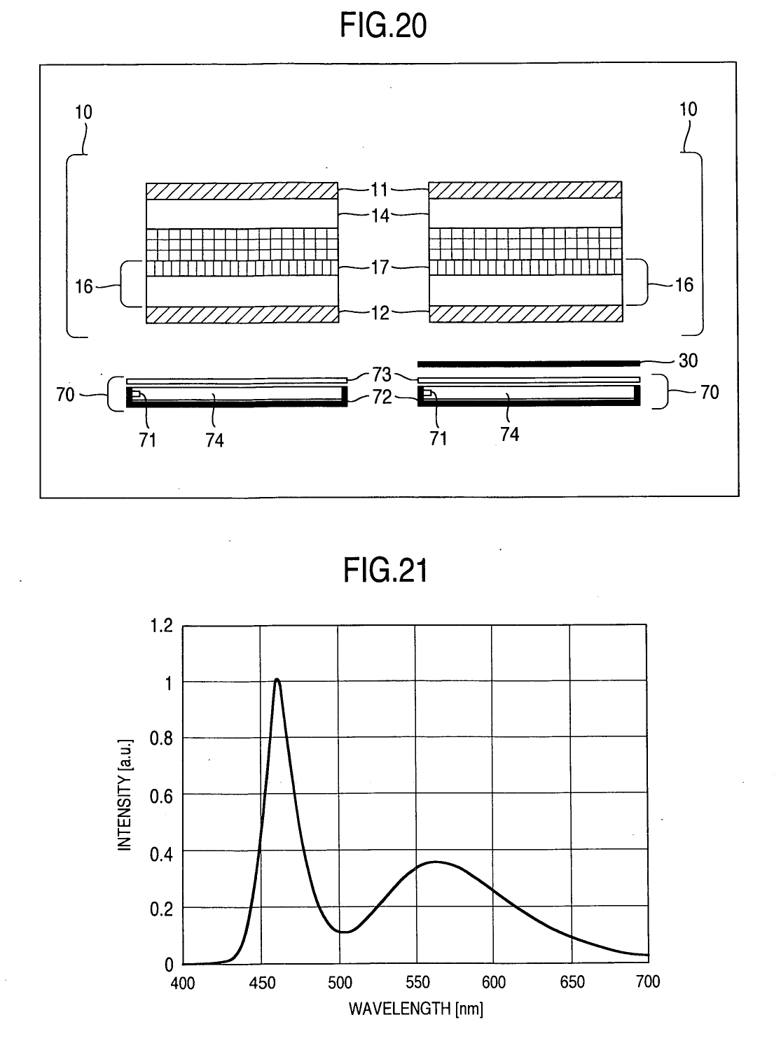

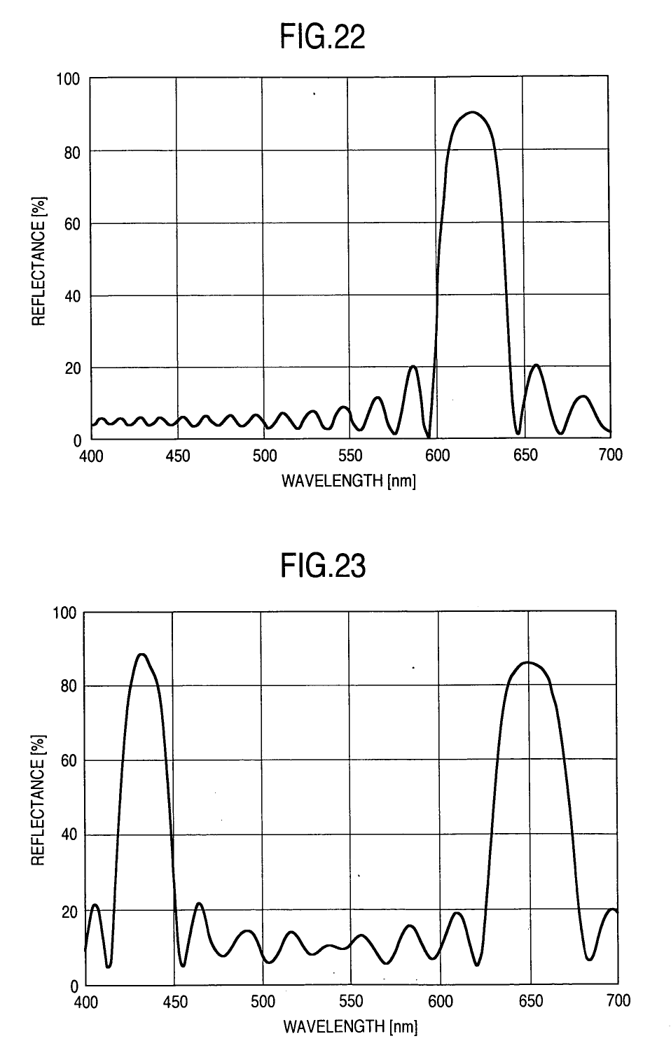

A structure of the liquid crystal display according to the present embodiment is shown in the right side of FIG. 20. In the present embodiment, a backlight unit 70 consisted of a light-emitting diode 71 of a light source, a light guide 74 for making light emitted from the light source arranged in a side face uniformly irradiate a front face of a display unit, a subsurface reflecting plate and subsurface frames 72, and a group of optical sheets 73 including a diffusing plate and a condensing sheet. Here, the light-emitting diode 71 is a white-light-emitting diode which emits blue to red rays by activating a phosphors with ultraviolet to blue rays. An emission spectrum provided by the backlight unit is shown in FIG. 21. A reflective polarizer 30 was placed between a backlight unit 70 and a liquid crystal display portion 10, and showed a spectral reflectance as shown in FIG. 22. The left side of FIG. 20 shows a liquid crystal display as a comparative object, which uses a general backlight unit using a white-light-emitting diode similar to that of the present embodiment. The white-light-emitting diode used in the present embodiment had photoelectric conversion efficiency approximately equal to that of a cold cathode fluorescent tube, but has poor color-rendering properties, and accordingly, when used as the light source in the liquid crystal display, can hardly expand a color specification range without decreasing the brightness efficiency of electric power of the display unit. As is understood from FIG. 21, the general white-light-emitting diode particularly has poor red-color-rendering properties. For this reason, the reflective polarizer used in the present embodiment was formed to have a maximum reflectance at a wavelength of about 620 nm. Thereby, the liquid crystal display could improve the red-color-rendering properties and the brightness. Specifically, the liquid crystal display in the left side of the FIG. 20 showed chromaticity of x=0.645 and y=0.336 in displaying red, whereas the liquid crystal display according to the present invention shown in the right side of FIG. 20 showed chromaticity of x=0.653 and y=0.330 in displaying red. The liquid crystal display also had the brightness in displaying white improved by about 3%. There are many white-light-emitting diodes which excite a phosphor by ultraviolet to blue rays other than the one used in the present embodiment, but have the same problem of balancing the color-rendering properties with luminous efficiency as in the present embodiment. For this reason, when the lighting unit lacks, for instance, in green-color-rendering properties, it is recommended for the liquid crystal display to employ a reflective polarizer having spectral reflectance characteristic as shown in FIG. 19.

### Embodiment 6

A structure of the liquid crystal display according to the present embodiment is shown in the right side of FIG. 1. The left side of FIG. 1 shows a general liquid crystal display as a comparative object. The reflective polarizer 30 showed the maximum reflectance at a wavelength of about 450 nm and a wavelength of about 650 nm as is shown in FIG. 23. The reflective polarizer was obtained, for instance, by preparing two different structures of the reflective polarizers shown in FIG. 3, and stacking them. It was obtained by the steps of: preparing birefringent films 30-A having a refractive index of 1.6 for an extraordinary ray and a film thickness of 70 nm, and isotropic layers having a refractive index of 1.5 and a film thickness of about 70 nm; stacking about 20 layers respectively to form one reflective polarizer; preparing birefringent films 30-A having a refractive index of 1.6 for an extraordinary ray and a film thickness of 105 nm, and isotropic layers having a refractive index of 1.5 and a film thickness of about 105 nm; stacking about 20 layers respectively to form the other reflective polarizer; and further stacking the prepared two reflective polarizers. As a result, the liquid crystal display according to the present embodiment greatly improved a color specification range and brightness in displaying white. It is also possible to further expand the color specification range by using such a phosphor as to improve color purity. In the present embodiment, a cold cathode fluorescent tube was used as a light source, but when intending to improve the color specification range of the liquid crystal display by a simple technique while keeping power consumption, it is recommended to use a reflective polarizer as is shown in FIG. 23 whatever the light source is.

It will be possible to present a liquid crystal display which has its power consumption and picture quality simultaneously improved.

It should be further understood by those skilled in the art that although the foregoing description has been made on embodiments of the invention, the invention is not limited thereto and various changes and modifications may be made without departing from the spirit of the invention and the scope of the appended claims.

1. A liquid crystal display comprising: a first substrate provided with a first polarizing plate in a light incident side; a second substrate provided with the other second polarizing plate; liquid crystal molecules sandwiched by the two substrates; a group of matrix-driven electrodes which applies an electric field to the liquid crystal layer and is arranged in a side close to the liquid crystal layer of at least one substrate of the first substrate and the second substrate; a color filter for trichromatic display placed on any one of the first substrate and the second substrate; and a backlight unit: wherein
a reflective polarizer is arranged between the first substrate and the backlight unit; when λ0 [nm] is defined as a wavelength at which a spectral reflectance R of the reflective polarizer (spectral reflectance when linear polarized light parallel to a reflection axis is perpendicularly incident) shows the maximum value, the reflective polarizer has such a wavelength λ0 [nm] that the following value R1 obtained by integrating the spectral reflectance with respect to a wavelength λ [nm] between λ0−50 [nm] and λ0+50 [nm]:
$$R 1 = {\int }_{λ0 - 50}^{λ0 - 50} R ⅆ λ$$
and the following value R2 obtained by integrating the spectral reflectance with respect to wavelengths between 400 nm and 700 nm:
$$R 2 = {\int }_{400}^{700} R ⅆ λ$$
satisfy the relation of R1/R2>0.4; and the reflective polarizer has a reflection axis in approximately parallel to an absorption axis of the first polarizing plate so as to form a smaller side angle of 0 to 10 degrees between them.

2. A liquid crystal display comprising: a first substrate provided with a first polarizing plate in a light incident side; the other second substrate provided with a second polarizing plate; liquid crystal molecules sandwiched by the two substrates; a group of matrix-driven electrodes which applies an electric field to the liquid crystal layer and is arranged in a side close to the liquid crystal layer of at least one substrate of the first substrate and the second substrate; a color filter for trichromatic display placed on any one of the first substrate and the second substrate; and a backlight unit: wherein
a reflective polarizer is arranged between the first substrate and the backlight unit; when λ0 [nm] is defined as a wavelength at which a spectral reflectance R of the reflective polarizer (spectral reflectance when linear polarized light parallel to a reflection axis is perpendicularly incident) shows the maximum value and R0 is defined as the maximum value of a spectral reflectance, the reflective polarizer has at least two such wavelengths as to satisfy the relation of R=R0/2 in a wavelength range of 700 nm or shorter, and such wavelengths that a wavelength λ1 [nm] which is larger than λ0 and has the minimum difference between itself and λ0 and a wavelength λ2 [nm] which is smaller than λ0 and has the minimum difference between itself and λ0 satisfy the relation of λ1=λ2<100 nm; and the reflective polarizer has a reflection axis in approximately parallel to an absorption axis of the first polarizing plate so as to form a smaller side angle of 0 to 10 degrees between them.

3. The liquid crystal display according to claim 1, wherein when λ0 is defined as a wavelength at which the spectral reflectance of the reflective polarizer shows the maximum value, the reflective polarizer has such λ0 as to satisfy the relation of λ0<500 nm.

4. The liquid crystal display according to claim 3, wherein the backlight unit employs a fluorescent tube as a light source.

5. The liquid crystal display according to claim 4, wherein the first polarizing plate and the second polarizing plate have respective absorption axes which are approximately perpendicular to each other so as to form a smaller side angle of 88 to 90 degrees between them; the liquid crystal molecules in the liquid crystal layer are oriented in a direction parallel to the substrate, and also approximately perpendicular or approximately parallel to the absorption axis of the first polarizing plate so as to form a smaller side angle of 0 to 2 degrees, and rotate in a plane parallel to the first substrate when an electric field is applied in a direction parallel to the first substrate; the group of matrix-driven electrodes each forming a pair of electrodes facing to each other in each pixel is arranged in a side close to the liquid crystal layer of either of the substrates of the first substrate and the second substrate; and the liquid crystal layer has a retardation of 300 nm or more when a voltage is not applied.

6. The liquid crystal display according to claim 5, wherein the fluorescent tube has such a phosphors as to show the maximum emission intensity at a wavelength of 620 nm or longer when exited by ultraviolet light with the wavelength of 254 nm sealed therein.

7. The liquid crystal display according to claim 6, wherein the reflective polarizer is formed by alternately stacking a birefringent film (with a difference of 0.05 or more between in-plane refractive indices) and an isotropic thin film; and
when two in-plane refractive indices of the birefringent film for incident light with the wavelength of 500 nm are represented by nxA and nyA, and the refractive index of the isotropic thin film for incident light with the wavelength of 500 nm is represented by nB, both refractive indices satisfy nyA≈nB, the birefringent film has a thickness smaller than 500/(4nxA), and the isotropic thin film has the thickness smaller than 500/(4nB).

8. The liquid crystal display according to claim 1, wherein the backlight unit employs the fluorescent tube as a light source, which has such a phosphors as to show the maximum emission intensity at a wavelength of 620 nm or longer when exited by ultraviolet light with a wavelength of 254 nm sealed therein; and when λ0 is defined as a wavelength at which the spectral reflectance of the reflective polarizer shows the maximum value, the reflective polarizer 30 has such λ0 as to satisfy the relation of λ0>600 nm.

9. The liquid crystal display according to claim 8, wherein the reflective polarizer is formed by alternately stacking a birefringent film (with a difference of 0.05 or more between in-plane refractive indices) and an isotropic thin film; and
when two in-plane refractive indices of the birefringent film for incident light with the wavelength of 600 nm are represented by nxA and nyA, and the refractive index of the isotropic thin film for incident light with the wavelength of 600 nm is represented by nB, both refractive indices satisfy the relation of nyA≈nB, the birefringent film has the thickness larger than 600/(4nxA), and the isotropic thin film has the thickness larger than 600/(4nB).

10. The liquid crystal display according to claim 1, wherein the backlight unit employs an element consisting of trichromatic light-emitting diodes as a light source; and when λ0 is defined as a wavelength at which the spectral reflectance of the reflective polarizer shows the maximum value, the reflective polarizer has such λ0 as to satisfy the relation of 500 nm<λ0<600 nm.

11. The liquid crystal display according to claim 10, wherein the reflective polarizer is formed by alternately stacking a birefringent film (with a difference of 0.05 or more between in-plane refractive indices) and an isotropic thin film; and
when two in-plane refractive indices of the birefringent film for an incident light with the wavelength of 500 nm are represented by nxA and nyA, and the refractive index of the isotropic thin film for the incident light wavelength of 500 nm is represented by nB, both refractive indices satisfy the relation of nyA≈nB, the birefringent film has the thickness larger than 500/(4nxA) but smaller than 600/(4nxA), and the isotropic thin film has the thickness larger than 500/(4nB) but smaller than 600/(4nB).

12. The liquid crystal display according to claim 1, wherein the backlight unit employs an element formed of a phosphor which emits visible light when exited by ultraviolet to blue rays emitted from a light-emitting diode 61 as a light source; and when λ0 is defined as a wavelength at which the spectral reflectance of the reflective polarizer shows the maximum value, the reflective polarizer has such λ0 as to satisfy the relation of λ0>550 nm.

13. The liquid crystal display according to claim 12, wherein the reflective polarizer is formed by alternately stacking a birefringent film (with an in-plane refractive index difference of 0.05 or more) and an isotropic thin film; and
when two in-plane refractive indices of the birefringent film for incident light with the wavelength of 550 nm are represented by nxA and nyA, and the refractive index of the isotropic thin film for an incident light with the wavelength of 550 nm is represented by nB, both refractive indices satisfy the relation of nyA≈nB, the birefringent film has the thickness larger than 550/(4nxA), and the isotropic thin film 30-B has the thickness larger than 550/(4nB).

14. The liquid crystal display according to claim 2, wherein when λB [nm] is defined as a wavelength at which a spectral reflectance R of the reflective polarizer shows the maximum value in a wavelength range of 500 nm or shorter, and RB is defined as the spectral reflectance, the reflective polarizer has at least two such wavelengths as to satisfy the relation of R=RB/2 in a wavelength range of 500 nm or shorter, and has two such wavelengths that a wavelength λB1 [nm] which is larger than λB and has the minimum difference between itself and λB and a wavelength λB2 [nm] which is smaller than λB and has the minimum difference between itself and λB satisfy the relation of λB1−λB2<100 nm; and when λD [nm] is defined as a wavelength at which the spectral reflectance R shows the maximum value in a wavelength range of 600 nm or longer and RD is defined as the spectral reflectance, the reflective polarizer has at least two such wavelengths as to satisfy the relation of R=RD/2 in a wavelength range of 600 nm or longer, and has two such wavelengths that a wavelength λD1 [nm] which is larger than XD and has the minimum difference between itself and λD and a wavelength λD2 [nm] which is smaller than λD and has the minimum difference between itself and λD satisfy the relation of λD1−λD2<100 nm.
